(19) United States
(12) Patent Application Publication
(10) Pub. No.: US 2026/0284815 A1
(43) Pub. Date: Sep. 24, 2026

(54) STORAGE DEVICE AND COOLANT SYSTEM

(71) Applicant: FANUC CORPORATION, Yamanashi (JP)

(72) Inventor: Ryutaro ISHIKAWA, Minamitsuru-gun (JP)

(21) Appl. No.: 19/476,346

(22) PCT Filed: Apr. 28, 2023
(86) PCT No.: PCT/JP2023/016924

§ 371 Date: Oct. 17, 2025

(51) Int. Cl. B23Q 11/00; B01D 29/27; B01D 36/04; B23Q 11/10

(52) U.S. Cl. CPC B23Q 11/0067; B01D 29/27; B01D 36/045; B23Q 11/1069

(57) ABSTRACT

This storage device comprises a housing, a container, and a cover. The housing accommodates the container for storing machining chips. Formed in the housing are: an opening for taking out the container; and an input port that is in communication with a separation device and is different from the opening.

### TECHNICAL FIELD

The present disclosure relates to a storage device and a coolant system.

### BACKGROUND ART

JP 7133736 B1 discloses a coolant supply device including a coolant tank, a circulation path, and a foreign matter capturing unit. The coolant tank stores a coolant supplied from a base of a machine tool. The circulation path is formed such that the coolant flows from the coolant tank and then returns to the coolant tank through the foreign matter capturing unit. The foreign matter capturing unit is configured by a cyclone separator that captures foreign matter such as chips or sludge contained in the coolant by using centrifugal force.

### SUMMARY OF THE INVENTION

However, JP 7133736 B1 does not disclose discharge of the foreign matter captured by the cyclone separator. There is room for improvement in the structure of discharging foreign matter (foreign material).

An aspect of the present disclosure is a storage device that stores machining chips separated by a separation device configured to separate, from a liquid, the machining chips contained in the liquid, the storage device including: a container configured to store the machining chips; a housing configured to accommodate the container, the housing including: an opening through which the container is taken out; and an input port communicating with the separation device and different from the opening; and a cover configured to cover the opening.

Another aspect of the present disclosure is a coolant system including: the storage device described above; and the separation device.

### BRIEF DESCRIPTION OF DRAWINGS

FIG. 1 is a schematic diagram of a coolant system;

FIG. 2 is a diagram showing a separation device and a storage device;

FIG. 3 is a diagram showing a positional relationship between an opening of a housing and the separation device; and

FIG. 4 is a diagram showing a separation device and a storage device according to a modification.

### DETAILED DESCRIPTION OF THE INVENTION

A pod-shaped container for storing foreign material (machining chips) captured by a cyclone separator (separation device) is known. The end of the pod-shaped container is open, and the opening at the end of the pod-shaped container is closed with a screw lid or a cap lid. A separation device is connected to the lid via a pipe. When the amount of the machining chips stored in the pod-shaped container increases, the lid is removed, and the machining chips stored in the pod-shaped container are scraped or scooped out through the opening at the end of the pod-shaped container. This scraping or scooping operation is cumbersome. Further, when the machining chips adhere to the matching surface (contact surface) of the lid to be joined to the pod-shaped container, it becomes difficult to close the opening at the end of the pod-shaped container with the lid, and cleaning of the matching surface and the like is required.

The following disclosure is intended to solve the above problems. In the following disclosure, an upward direction and a downward direction are defined. The upward direction is a direction opposite to the direction in which gravity acts. The downward direction is a direction in which gravity acts.

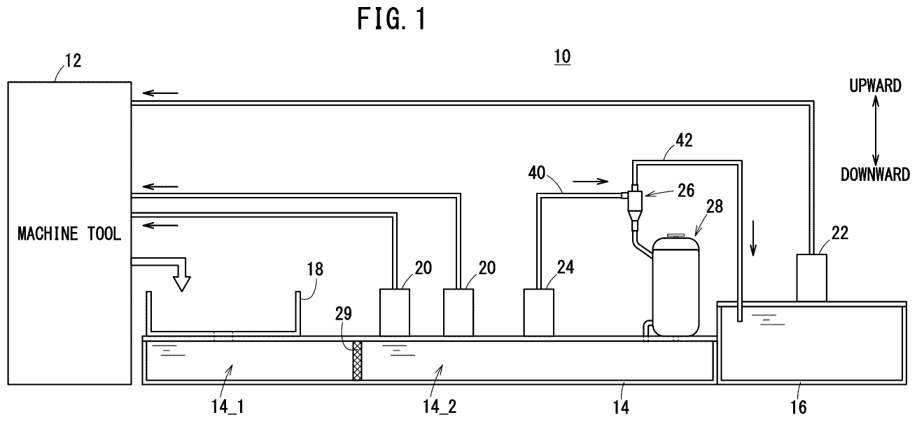

As shown in FIG. 1, a coolant system 10 is a system that separates machining chips from a coolant containing the machining chips generated by machining with a machine tool 12, and supplies the coolant from which the machining chips have been separated to the machine tool 12. Examples of the machine tool 12 include a cutting machine, a lathe machine, and a grinding machine. The coolant is a liquid. In general, a liquid obtained by dissolving a water-soluble agent in water is used as a coolant. The coolant is used to improve machining performance when machining is performed by the machine tool 12, to cool machining heat, or to discharge machining chips generated by machining to the outside of the machine.

The coolant system 10 includes a first liquid tank 14, a second liquid tank 16, a coolant receiving member 18, a first liquid pressure pump 20, a second liquid pressure pump 22, a delivery pump 24, a separation device 26, and a storage device 28.

The first liquid tank 14 is a tank that stores a coolant containing machining chips. The first liquid tank 14 is partitioned into a dirty-liquid tank 14_1 and a primary clean-liquid tank 14_2 by a porous filter member 29. The dirty-liquid tank 14_1 and the primary clean-liquid tank 14_2 communicate with each other via the porous filter member 29. The porous filter member 29 partitions the first liquid tank 14 into the dirty-liquid tank 14_1 and the primary clean-liquid tank 14_2. The porous filter member 29 captures the machining chips contained in the coolant stored in the dirty-liquid tank 14_1. As a result, the coolant stored in the primary clean-liquid tank 14_2 becomes a coolant from which the machining chips have been removed. However, the porous filter member 29 cannot completely capture the machining chips. Therefore, the coolant stored in the primary clean-liquid tank 14_2 contains the machining chips. However, the amount of the machining chips contained in the coolant stored in the primary clean-liquid tank 14_2 is smaller than the amount of the machining chips contained in the coolant stored in the dirty-liquid tank 14_1.

The second liquid tank 16 is a secondary clean-liquid tank that stores a coolant from which the machining chips have been separated by the separation device 26. Since the coolant stored in the second liquid tank 16 has passed through the separation device 26, the amount of the machining chips contained in that coolant is smaller than that of the machining chips contained in the coolant stored in the primary clean-liquid tank 14_2.

The coolant receiving member 18 is a member for receiving the coolant discharged from the machine tool 12 and transferring the coolant into the dirty-liquid tank 14_1. The coolant discharged from the machine tool 12 contains machining chips. The coolant receiving member 18 is installed on, for example, the top plate of the first liquid tank 14.

The first liquid pressure pump 20 is a pump that pumps the coolant stored in the primary clean-liquid tank 14_2 to the machine tool 12. The first liquid pressure pump 20 is installed on, for example, the top plate of the first liquid tank 14. In FIG. 1, the number of the first liquid pressure pumps 20 is two, but may be one or three or more. The coolant pumped to the machine tool 12 by the first liquid pressure pump 20 is discharged to, for example, a splash guard of the machine tool 12.

The second liquid pressure pump 22 is a pump that pumps the coolant stored in the second liquid tank 16 to the machine tool 12. The second liquid pressure pump 22 is installed on, for example, the top plate of the second liquid tank 16. In FIG. 1, the number of the second liquid pressure pumps 22 is one, but may be two or more. The coolant pumped to the machine tool 12 by the second liquid pressure pump 22 is supplied to, for example, a through hole formed in a spindle of the machine tool 12. In this case, the coolant is discharged from a through hole of the tool attached to the spindle to a machining portion of the tool.

The delivery pump 24 is a pump that pumps the coolant stored in the primary clean-liquid tank 14_2 to the separation device 26. The delivery pump 24 is installed, for example, on the top plate of the first liquid tank 14. The delivery pump 24 supplies the coolant stored in the primary clean-liquid tank 14_2 to the separation device 26 via an input pipe line 40.

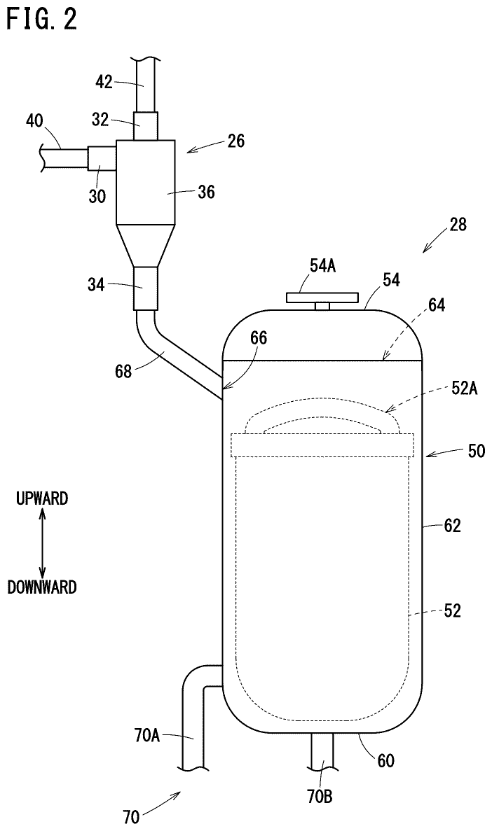

The separation device 26 is a separator that separates the machining chips contained in the coolant. The separation device 26 may be a cyclone filter. The separation device 26 separates the machining chips contained in the coolant supplied from the primary clean-liquid tank 14_2 via the input pipe line 40, and supplies the coolant from which the machining chips have been separated to the second liquid tank 16 via an output pipe line 42. As illustrated in FIG. 2, the separation device 26 includes an input unit 30, a clean-liquid output unit 32, a dirty-liquid output unit 34, and a main body unit 36.

The input unit 30 is disposed on, for example, an upper side surface of the main body unit 36. The input unit 30 is connected to the input pipe line 40 and communicates with the delivery pump 24 (FIG. 1). The clean-liquid output unit 32 is disposed, for example, on an upper portion of the main body unit 36, and is connected to the output pipe line 42. The dirty-liquid output unit 34 is provided, for example, on a lower portion of the main body unit 36, and communicates with the storage device 28.

The main body unit 36 is a portion that executes a process of separating the machining chips from the coolant. In a case where the separation device 26 is a cyclone filter, the main body unit 36 separates the machining chips from the coolant by centrifugal force. In this case, the coolant flowing from the input unit 30 to the main body unit 36 is spun in the main body unit 36. The machining chips contained in the coolant settle out while moving radially outward to the vicinity of the outer wall of the cyclone filter by the centrifugal force due to the spinning, and those machining chips flow out to the storage device 28 together with part of the coolant via the dirty-liquid output unit 34. As a result, the central portion of the cyclone filter is substantially free of machining chips, and clean coolant is supplied from the clean-liquid output unit 32 to the output pipe line 42.

The storage device 28 is a device that stores the machining chips separated by the separation device 26. The storage device 28 includes a housing 50, a container 52, and a cover 54.

The housing 50 is located below the separation device 26. The housing 50 is installed on, for example, the top plate of the first liquid tank 14. The housing 50 is formed so as to be able to accommodate the container 52. The housing 50 has a bottom wall 60, a side wall 62, and an opening 64. The side wall 62 is connected to a rim of the bottom wall 60, and extends from the bottom wall 60 in a direction (upward direction) opposite to the direction of gravity. The opening 64 is provided for taking the container 52 into and from the housing. The opening 64 is located on the opposite side of the housing from the bottom wall 60 and is surrounded by the upper end portion of the side wall 62.

The housing 50 may be formed such that the inside of the housing 50 can be visually recognized from the outside of the housing 50. For example, the entire housing 50 is formed of a transparent resin, glass, or the like. Alternatively, a window may be formed in a part of the housing 50. In the case that the housing 50 is formed such that the inside can be visually recognized from the outside, the operator can check the storage state of the housing 50 without the need of looking into the inside of the housing 50 from the opening 64.

The housing 50 further includes an input port 66, separately from the opening 64. The input port 66 is located below the opening 64 and communicates with the dirty-liquid output unit 34 of the separation device 26. The input port 66 may communicate with the dirty-liquid output unit 34 via a tube 68.

The input port 66 is supplied with the machining chips together with a small amount of coolant from the separation device 26. The housing 50 may be provided with a drain portion 70 to drain the coolant flowing into the housing through the input port 66, from the housing 50.

In the present embodiment, the drain portion 70 includes a first drain pipe 70A and a second drain pipe 70B. The first drain pipe 70A is attached to the side wall 62 of the housing 50, and establishes communication between the inside of the housing 50 and the primary clean-liquid tank 14_2. The second drain pipe 70B is attached to the bottom wall 60 of the housing 50, and establishes communication between the inside of the housing 50 and the primary clean-liquid tank 14_2.

The drain portion 70 may include only one of the first drain pipe 70A and the second drain pipe 70B. Further, the drain portion 70 may be a through hole formed in the housing 50, instead of the first drain pipe 70A and the second drain pipe 70B. The drain portion 70 can cause the coolant existing in the housing 50 to flow to the primary clean-liquid tank 14_2 through the through hole. The through hole may be closed with a closing member such as a cap or a plug. In a case where the through hole is closed with the closing member, the closing member is removed from the through hole during a certain opening period such as during its maintenance. The drain portion 70 may also establish communication between the housing 50 and the coolant receiving member 18 or between the housing 50 and the dirty-liquid tank 14_1.

The container 52 is a member that stores the machining chips. The container 52 is housed inside the housing 50. The opening of the container 52 is located at the upper end of the container and faces in the same direction as the opening 64 of the housing 50.

The opening of the container 52 is located below the input port 66. Therefore, the machining chips flowing in from the input port 66 are guided to the container 52 by gravity and stored therein.

The container 52 can be taken out from the opening 64 of the housing 50. For example, when the amount of the machining chips stored in the container 52 increases, the container 52 is taken out from the opening 64. In this case, another container 52 without no machining chips stored is accommodated again inside the housing 50. A handle 52A is formed on the upper part of the container 52. Alternatively, the handle 52A may not be formed.

The container 52 may be formed as a bag-shaped film. In this case, the weight of the container 52 can be reduced, and this makes it easy to carry the container 52 with the machining chips stored.

The container 52 may be formed so as to be permeable to the coolant. For example, the container 52 may be formed so as to have a plurality of micro pores, so that the container 52 can become permeable to the coolant. Alternatively, the container 52 is formed in a net-shaped fashion, so that the container 52 can be permeable to the coolant. In the case where the container 52 is formed so as to be permeable to the coolant, the machining chips supplied from the separation device 26 can be stored, and the coolant supplied together with the machining chips can be discharged to the outside of the container 52. As a result, the container 52 with the machining chips stored is easy to carry. In the case where the container 52 is formed so as to be permeable to the coolant, the coolant can be returned to the primary clean-liquid tank 14_2 when the housing 50 is provided with the drain portion 70.

The cover 54 covers the opening 64 of the housing 50. The cover 54 is supported by an upper portion of the side wall 62 of the housing 50 surrounding the opening 64. The cover 54 may be attached to the housing 50 or the like so as to be able to open and close the opening 64. For example, the cover 54 may be detachably attached to the housing 50, or may be slidably attached to the housing 50. The cover 54 may be pivotably attached to the housing 50 via a hinge or the like. A handle 54A is formed on the upper part of the cover 54. The handle 54A may not be formed.

The cover 54 may be formed such that the inside of the housing 50 can be visually recognized from the outside of the cover 54. For example, the entire cover 54 is formed of a transparent resin, glass, or the like. Alternatively, a window may be formed in a part of the cover 54. In the case where the cover 54 is formed such that the inside of the housing 50 can be visually recognized from the outside of the cover 54, the operator can check the storage state of the housing 50 without the need of removing the cover 54.

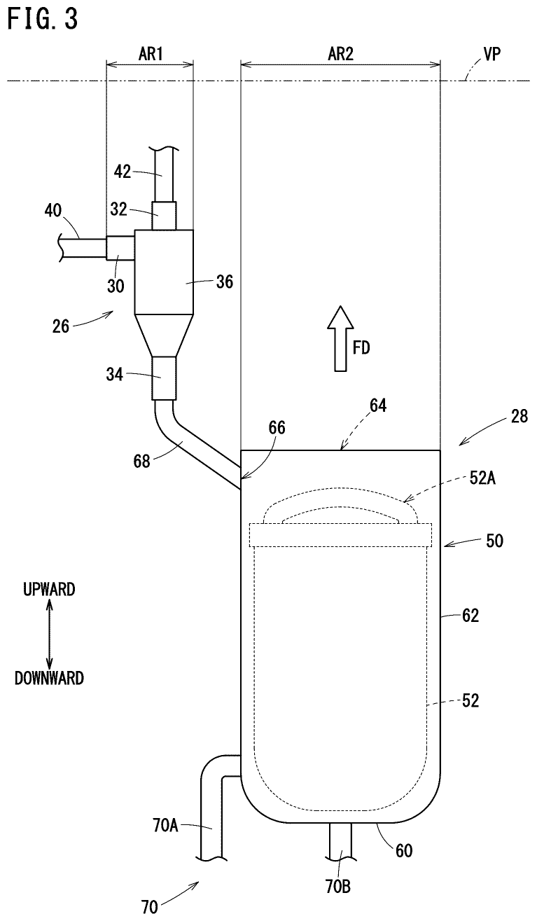

As shown in FIG. 3, a first projected region AR1 and a second projected region AR2, which are projected on an imaginary plane VP orthogonal to a taking-out direction FD in which the container 52 is taken out, are spaced apart from each other. The first projected region AR1 is a region of the separating device 26 projected onto the imaginary plane VP. The second projected region AR2 is a region of the opening 64 projected onto the imaginary plane VP.

The first projected region AR1 and the second projected region AR2 are spaced apart from each other, and thus the opening 64 can be easily exposed from the cover 54. In addition, the container 52 can be easily taken out from the exposed opening 64.

As described above, in the storage device 28 of the present embodiment, the container 52 for storing the machining chips is housed inside the housing 50. The housing 50 has the opening 64 through which the container 52 is taken out. Thus, the machining chips can be taken out without the need of scraping or scooping out the machining chips.

In the storage device 28 of the present embodiment, the input port 66 communicating with the separation device 26 is formed in the housing 50, not in the cover 54 covering the opening 64 of the housing 50. This makes it difficult for the machining chips to adhere to the matching surface (contact surface) of the cover 54. Further, by taking out the container 52 at the time of cleaning, the machining chips do not adhere to the opening 64. As a result, the cleaning process can be efficiently improved as compared with the case where the opening 64 is closed with a screw lid or a cap lid.

The above embodiment may be modified as follows.

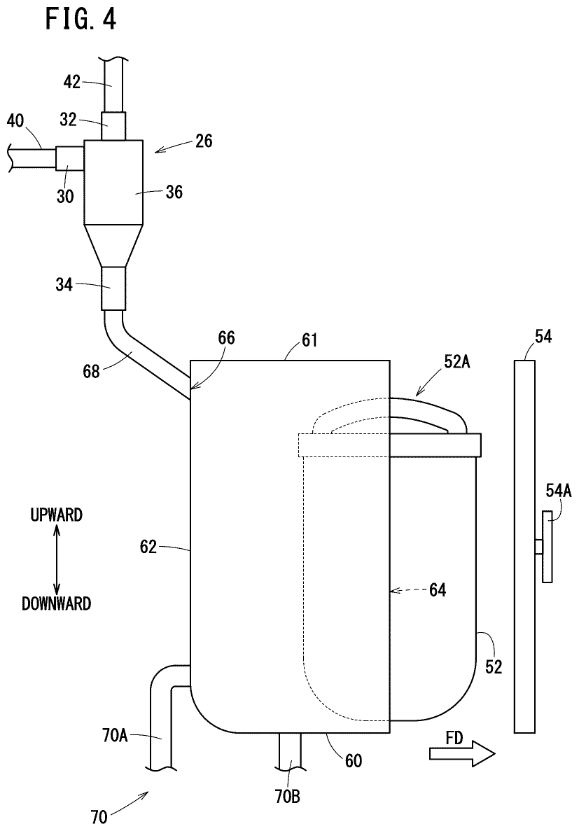

As shown in FIG. 4, the opening 64 may be arranged such that the separation device 26 is located in a region on a side different from the taking-out direction FD of the container 52 with respect to the housing 50. FIG. 4 illustrates a case where the separation device 26 is located in a region on a side of the housing 50 opposite to the taking-out direction FD in which the container 52 is taken out. In this case, the opening 64 is located on a side of the housing opposite from the side wall 62 disposed between the bottom wall 60 and the top wall 61. The opening 64 is surrounded by an end portion of the bottom wall 60 and an end portion of the top wall 61. The cover 54 is attached to the housing 50 or the like by an attachment tool so as not to fall off from the housing 50.

The separation device 26 is not limited to being located in the region on the side of the housing 50 opposite to the taking-out direction FD in which the container 52 is taken out. For example, the separation device 26 may be located in a region on an obliquely upper side of the housing 50 in the taking-out direction FD of the container 52. Alternatively, the separation device 26 may be located in a region on an obliquely lower side of the housing 50 in the taking-out direction FD of the container 52.

In this way, in the case where the opening 64 is disposed such that the separation device 26 is located in a region on a side different from the taking-out direction FD of the container 52 with respect to the housing 50, the opening 64 is easily exposed from the cover 54. In addition, the container 52 can be easily taken out from the exposed opening 64.

The following Supplementary Notes are disclosed in relation to the above embodiment.

### Supplementary Note 1

The present disclosure is the storage device (28) that stores the machining chips separated by the separation device (26) that separates, from the liquid, the machining chips contained in the liquid, the storage device including: the container (52) that stores the machining chips, the housing (50) that accommodates the container; the housing including: the opening (64) through which the container is taken out; and the input port (66) communicating with the separation device and different from the opening; and the cover (54) that covers the opening.

### Supplementary Note 2

In the storage device according to Supplementary Note 1, the first projected region (AR1) of the separation device projected on the imaginary plane (VP) orthogonal to the taking-out direction (FD) of the container in which the container is taken out and the second projected region (AR2) of the opening projected on the imaginary plane may be spaced apart from each other.

### Supplementary Note 3

In the storage device according to Supplementary Note 1 or 2, the opening may be provided on an upper side of the container.

### Supplementary Note 4

In the storage device according to any one of Supplementary Notes 1 to 3, the container may be formed so as to be permeable to the liquid.

### Supplementary Note 5

In the storage device according to any one of Supplementary Notes 1 to 4, the container may be formed as a bag-shaped film.

### Supplementary Note 6

In the storage apparatus according to any one of Supplementary Notes 1 to 5, the container may be located below the input port.

### Supplementary Note 7

In the storage device according to Supplementary Note 2, the opening may be disposed such that the separation device is located in a region on a different side of the housing from the taking-out direction of the container.

### Supplementary Note 8

The present disclosure is a coolant system (10) including: the storage device according to any one of Supplementary Notes 1 to 7; and the separation device.

Although the present disclosure has been described in detail, the present disclosure is not necessarily limited to each of the respective embodiment and modifications. In the embodiment and the modifications, various addition, replacement, changing, partial deletion, and the like can be made without departing from the essence and gist of the present disclosure or without departing from the essence and gist of the present disclosure derived from the contents described in the claims and equivalents thereof. Further, the embodiment and the modifications can also be implemented together in combination. For example, in the above-described embodiment and the modifications, the order of each of the operations and the order of each of the processes are merely shown as examples, and the present invention is not necessarily limited to these examples. Further, the same applies in the case that numerical values or mathematical expressions are used in the description of the aforementioned embodiment and modifications.

### REFERENCE SIGNS LIST

10: coolant system
12: machine tool
14: first liquid tank
16: second liquid tank
18: coolant receiving member
20: first liquid pressure pump
22: second liquid pressure pump
24: delivery pump
26: separation device
28: storage device
50: housing
52: container
54: cover
64: opening
66: input port

1. A storage device that stores machining chips separated by a separation device configured to separate, from a liquid, the machining chips contained in the liquid, the storage device comprising:
a container configured to store the machining chips;
a housing configured to accommodate the container, the housing including: an opening through which the container is taken out; and an input port communicating with the separation device and different from the opening; and
a cover configured to cover the opening.

2. The storage device according to claim 1, wherein
a first projected region of the separation device projected on an imaginary plane orthogonal to a taking-out direction of the container in which the container is taken out and a second projected region of the opening projected on the imaginary plane are spaced apart from each other.

3. The storage device according to claim 1, wherein
the opening is provided on an upper side of the container.

4. The storage device according to claim 1, wherein
the container is formed so as to be permeable to the liquid.

5. The storage device according to claim 1, wherein
the container is formed as a bag-shaped film.

6. The storage device according to claim 1, wherein
the container is located below the input port.

7. The storage device according to claim 2, wherein
the opening is disposed in a manner so that the separation device is located in a region on a different side of the housing from the taking-out direction of the container.

8. A coolant system comprising: the storage device according to claim 1 and the separation device.
